(19) United States
(12) Patent Application Publication
(10) Pub. No.: US 2003/0228846 A1
(43) Pub. Date: Dec. 11, 2003

(54) Method and system for radio-frequency proximity detection using received signal strength variance

(76) Inventors: Shlomo Berliner, Kiriat Ono (IL); Daniel Aijadeff, Kiriat Ono (IL); Reuven Amsalem, Nes-ziona (IL)

Correspondence Address: WEISS & MOY PC, 4204 NORTH BROWN AVENUE, SCOTTSDALE, AZ, 85251, US

(21) Appl. No.: 10/452,547

(22) Filed: Jun. 2, 2003

Related U.S. Application Data
(60) Provisional application No. 60/386,493, filed on Jun. 5, 2002.

(51) Int. Cl. H04B 17/00

(52) U.S. Cl. 455/67.11; 455/422.1

(57) ABSTRACT

A method and system for radio-frequency proximity detection uses received signal strength variance to determine proximity distance. A signal is received from a transmitting device by a receiving device and the variance of the signal computed over time. One or more ranges can be established to determine whether or not the variance falls within the expected range. A lower variance indicates a shorter proximity distance and therefore signals from devices within a variance range are established as being within a particular distance range. Denial/granting of service, or restricting of services can be performed in response to determining that a transmitting device is outside of a variance range. Variance computations can be performed at both ends of a transceiver link and results communicated and compared at both transceivers to further improve the accuracy of the proximity determination.

### RELATED APPLICATIONS

This application is related to U.S. provisional application Ser. No. 60/386,493, filed Jun. 5, 2002 and from which it claims benefits under 35 U.S.C. §119(e).

### BACKGROUND OF THE INVENTION

1. Field of the Invention

The present invention relates generally to radio-frequency distance measuring systems, and more specifically, to a method and system for locating a transmitting device using a measured received signal strength variance.

2. Background of the Invention

Wireless data communications, voice communications and control devices are finding increasing use in home, office and industrial applications. In many “short range” wireless applications, it is essential or at least desirable to know whether two or more devices are in close proximity. Typical applications are secure data transfer, wireless payments, proximity based equipment activation and other applications where the proximity of a device provides a clue as to whether the identity or locale of a transmitter is consistent with expectations of security.

Estimation of distance between two radio devices is traditionally done by measuring either the strength of a received signal, or the propagation delay of a two way signal. The signal strength techniques (Received Signal Strength Indication—RSSI) performance is poor at best in terms of accuracy and reliability, as propagation loss is highly dependent on environmental conditions and the received signal is affected by fading due to multi-path propagation. In addition, distance estimation requires cooperation from a detected party, as the transmitter power is typically unknown for a transmitting device unless the transmitting device communicates the transmitter power to the distance detecting receiver or the receiver transmits the RSSI to the transmitting device.

Further, transmitter power tolerances, antenna gain variations and attenuation due to obstructions such as human bodies degrade the overall reliability of an RSSI-based proximity measurement.

Propagation delay-based distance measurement methods yield accurate and reliable results, but usually require additional circuitry and complexity in both transmitters and receivers. Propagation delay-based distance measurement also typically requires special transmission packets and sophisticated algorithms to compensate for fading and motion of the transmitting and receiving devices.

Therefore, it would be desirable to provide a signal strength-based distance measuring technique and system that have improved performance in the face of fading, system component variations and signal absorption.

### SUMMARY OF THE INVENTION

The above objectives of providing improved signal strength-based distance measuring are achieved in a method and system. The method is embodied in a receiver system that determines a physical location or distance of a transmitting wireless device by measuring the variance of a received signal over time and comparing the variance to predetermined ranges of variance. A device that falls outside of a predetermined range can be denied service or services can be restricted for that device, providing enhanced security and/or reliability of communications. Variance measurements can be performed at both ends of a transceiver link, and the results exchanged between transceivers, providing improved accuracy of the variance computation.

The foregoing and other objectives, features, and advantages of the invention will be apparent from the following, more particular, description of the preferred embodiment of the invention, as illustrated in the accompanying drawings.

### BRIEF DESCRIPTION OF THE DRAWINGS

FIG. 1 is a graph depicting variance of signal strength as measured in a system in accordance with an embodiment of the present invention.

FIG. 2 is a block diagram of a location finding unit in accordance with an embodiment of the present invention.

FIG. 3 is a graph depicting operation of multiple location finding units in accordance with an embodiment of the present invention.

FIG. 4 is a flowchart depicting a method in accordance with an embodiment of the present invention.

### DETAILED DESCRIPTION OF THE ILLUSTRATIVE EMBODIMENT

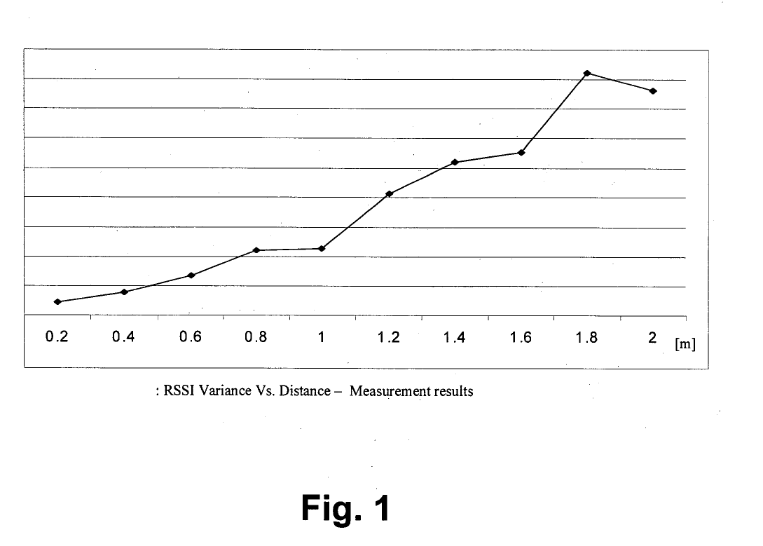

The present invention provides a method and system for determining a proximity distance of a transmitting device by measuring the amplitude of a signal received at a receiver. The amplitude measurement is improved over prior amplitude measurements, with a consequent improvement in estimation accuracy of the distance between the transmitter and receiver. Referring now to FIG. 1, a graph depicting signal strength variance versus distance between transmitter and receiver is depicted. As is evident from the graph, variance of the signal strength increases with separation distance between the transmitter and receiver, and the present invention uses the variance information to provide improved proximity detection. Variance is a statistical quantifier given for finite number of samples n by the formula:

var=[n·Σs²−(Σs²)]/[n·(n−1)]

where:

n is the number of samples

s is a recorded signal strength, expressed in linear (volts, watts) or logarithmic (dBm) terms.

The statistical variance of the strength of a received signal at a wireless device is strongly correlated to the distance from the transmitter, particularly in short range (0 to 5 m) communication links. Therefore, determining the variance of the received signal yields a strong indicator of proximity distance that can be used to implement an improved amplitude-based proximity detection system and method.

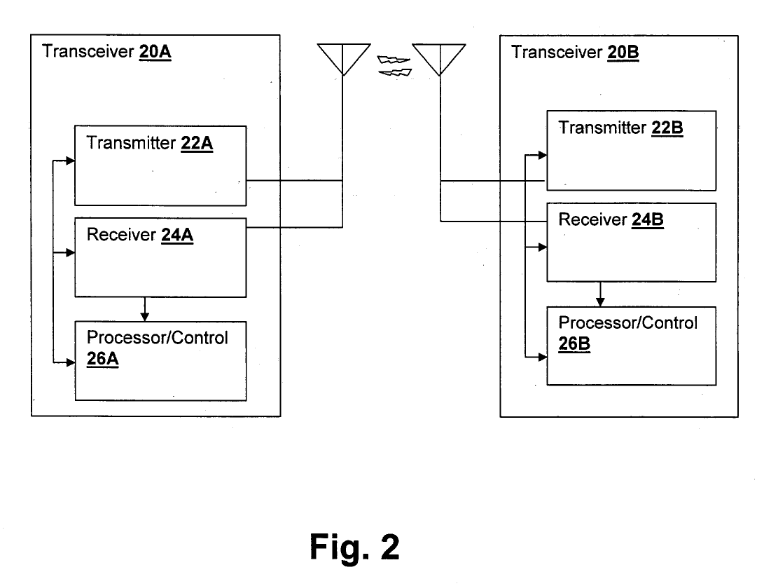

Referring now to FIG. 2, a pair of transceivers 20A and 20B in accordance with an embodiment of the invention and forming a system in accordance with an embodiment of the invention are depicted. Transceivers 20A and 20B each comprise a transmitter 22A and 22B and a receiver 24A and 24B coupled to antennas 21A and 21B, whereby the transceivers exchange RF signals carrying voice, data, video or other information. The communications channel may be a discrete channel or a shared mechanism such as Spread Spectrum, including frequency hopping or in a direct sequence system. In general, the system depicted in FIG. 2 applies to wireless devices including receive-only and transmit-only devices, as the present invention can be practiced in a receiver having no transmit capability in response to an external transmitter having no receive capability. Within each of transceivers 20A and 20B is a processor/control block 26A and 26B, that provides computation and control in accordance with embodiments of the present invention.

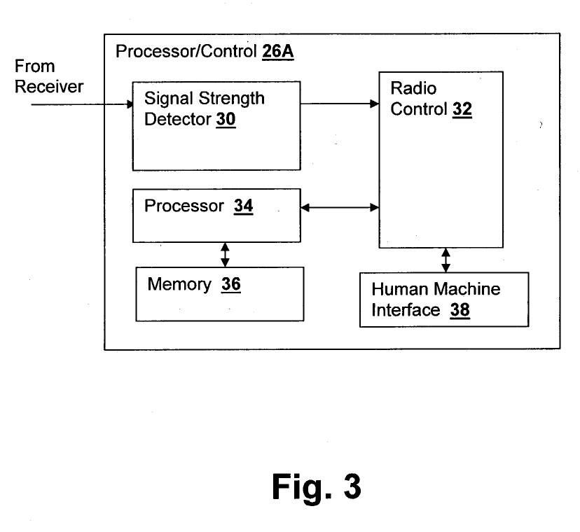

Referring now to FIG. 3, details of processor/control block 26A (and similarly processor/control block 26B) is shown. Processor/control block 26A includes a signal strength detector 30 that is coupled to a signal from receiver 24A that is proportional to received signal strength at receiver 24A. Signal strength detector is coupled to radio control, which delivers a numeric indication of received signal strength to a processor 34. Processor 34 is coupled to a memory 36 that contains program instructions for execution by processor 34, including program instructions for carrying out methods in accordance with an embodiment of the present invention. Radio control 32 is also coupled to a human machine interface (HMI) for providing an interface of transceiver 20A accessible by a user (e.g., an LCD display and a keypad).

Processor 34 computes the variance of the detected received signal strength provided by radio control 32 and makes determinations of proximity from the variance. The signal strength measurement and is repeated periodically during normal communication and a variance is computed over a predetermined number of samples (100 in this illustration). For example, the variance can be computed every 100 ms on a sample interval of 1 ms. Sampling of the signal strength (RSSI) can be performed on a single channel or on multiple channels (e.g., in frequency hopping systems).

In the illustrative embodiment, radio control 32 in transceiver 20A sets the receiver 24A reception frequency, range of frequencies, or channel. Then, radio control 32 provides the output of signal strength detector 30 to processor 34, which computes the variance over a number of collected signal strength samples. After the variance value is computed, processor 34 compares the variance to predefined limit criteria, and a decision is made whether the detected device is within a certain proximity range. The proximity decision can be used to authorize an operation, (e.g. open a door) or be displayed to a user for further actions. Alternatively, processor 34 can estimate a distance from the variance and limits can be applied to the distance estimation.

The proximity decision can be performed at both ends of a communication link, e.g., transceiver 20A can compute the signal strength variance of a signal received from transceiver 20B and transceiver 20B can compute the signal strength variance of a signal received from transceiver 20A. Comparison of the results by exchanging variance or proximity data between transceivers 20A and 20B yields an improvement in accuracy of the proximity measurement, as the results should ideally be symmetric (i.e., the distance is identical).

Further computation by processor 34 may be performed, The confidence level of the result computed from the variance can be further enhanced by various techniques and algorithms, including majority voting, filtering, and multiple sampling rates computations. Interference immunity can be provided or improved by one or more of several mechanisms. Where the integrity of the received signal is constantly monitored, RSSI readings may be gated to remove noise spikes and/or to remove any readings, when the received error rate exceeds a specific threshold, thus removing spurious samples from the variance computation. Also, where many channels are involved in the communication link such as in frequency hopping systems, channel readings can be skipped if its RSSI or RSSI variances are significantly different from the majority of the other channels, which indicates corruption due to narrow band interference.

Additional variables can also be added to the proximity formula, providing a proximity decision in conformity with a function of RSSI variance, error rate and absolute RSSI. Further, if an indication of transmitter power is sent from the transmitting device (i.e., numeric data corresponding to absolute transmitter power), then absolute path loss and path loss variance can be computed and used to compute the proximity indication.

The methods of the present invention are suitable for short range detection applications, where received signals are normally strong enough to produce a high signal to noise ratio (SNR), which improves the reliability of the results. In cases where the signals are too strong and cause saturation of the RSSI measurement, which is a condition easily detectable by the wireless devices. The saturation indication can be considered a proximity indication overriding the variance decision, or front-end attenuation can be inserted in the receive path to eliminate saturation.

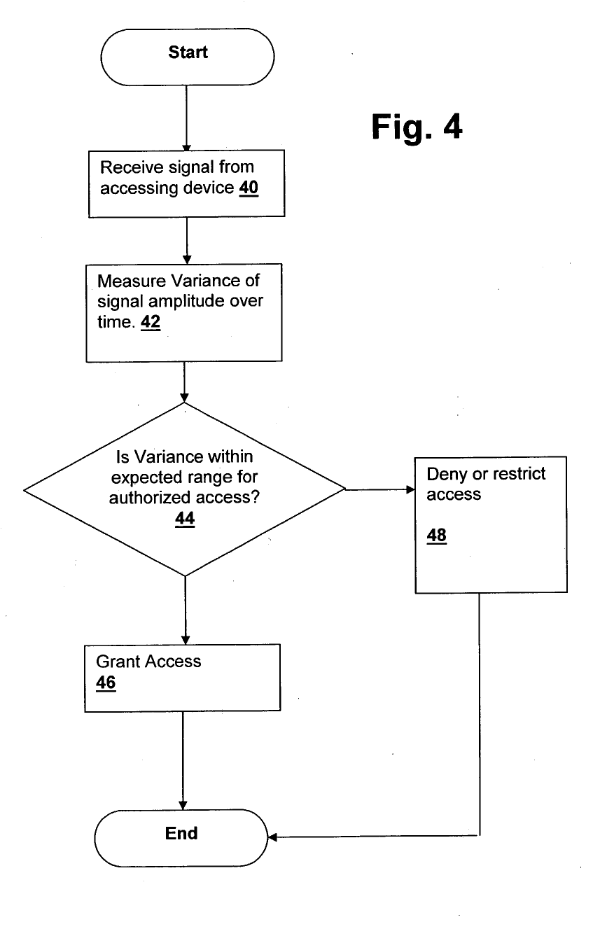

Referring now to FIG. 4, a method in accordance with an embodiment of the present invention is depicted. First, a signal is received from an accessing (transmitting) device (step 40). Next, the variance of the received signal is measured over time (step 42). If the computed variance is within the expected range for authorized access (decision 44), then access is granted (step 46B). If the computed variance is not within the expected range (decision 44), access is denied or restricted (step 48). While the method depicted is described in terms of a security-type model, the variance decision-based techniques of the present invention are equally applicable to other proximity detection uses, such as using a proximity indication to validate a communication to avoid or reduce channel errors.

There are many advantages of the techniques of the present invention. One is simple implementation, as most or all of the components necessary to carry out the method of the present invention exist within many wireless devices already, with the exception of program instructions for carrying out the method of the present invention. The above-illustrated techniques are also flexible as the sampling rate, sample population and number of trials may be adjusted and optimized for a particular application. The techniques are also autonomous, requiring no information on transmitting power from the transmitting device in order to implement the basic method of the present invention. The variance is also, only slightly affected by environmental conditions and for known conditions, the detection ranges may be adjusted.

While the invention has been particularly shown and described with reference to the preferred embodiments thereof, it will be understood by those skilled in the art that the foregoing and other changes in form, and details may be made therein without departing from the spirit and scope of the invention.

What is claimed is:

1. A method for determining proximity between a first wireless device and a second wireless device, said method comprising:
receiving a first signal from said first wireless device at said second wireless device;
in response to said receiving, determining a signal strength of said received signal;
computing a variance of said signal strength over time; and
determining whether or not said first wireless device is within a proximity range of said second wireless device in conformity with said computed variance.

2. The method of claim 1, further comprising computing an estimated distance in conformity with said computed variance, and wherein said determining determines whether or not said estimated distance is within said proximity range.

3. The method of claim 1, wherein said determining determines whether or not said variance falls within one or more predetermined ranges, whereby a proximity level of said distance is determined.

4. The method of claim 3, further comprising in response to determining that said variance is greater than an upper bound of a given one of said predetermined ranges, denying access of said first wireless device to said second wireless device.

5. The method of claim 4, wherein said denying denies access to a subset of services available at said second wireless device.

6. The method of claim 5, wherein said second wireless device is coupled to an electromechanical lock and said subset of services includes opening said electromechanical lock.

7. The method of claim 1, further comprising providing a display to a user of a result of said determining, whereby said user can take further action.

8. The method of claim 1, further comprising:
transmitting a second signal from said second wireless device;
second receiving said second signal at said first wireless device;
in response to said receiving, determining a second signal strength of said received second signal; and
computing a second variance of said second signal strength over time.

9. The method of claim 8, further comprising determining whether or not said first wireless device is within a proximity range of said second wireless device in conformity with said computed second variance.

10. The method of claim 8, further comprising:
transmitting a indication of said first variance from said second wireless device;
receiving said indication at said first wireless device; and
determining whether or not said first wireless device is within a proximity range of said second wireless device in conformity with said received indication and said second variance.

11. A wireless receiver, comprising:
an antenna;
a receiver subsystem coupled to said antenna for detecting signals received from said antenna;
an amplitude detector coupled to said receiver subsystem for detecting an amplitude of said received signals; and
a processing subsystem coupled to said amplitude detector for computing a variance of said received signals and determining a proximity level of a transmitting source of said signal in conformity with said variance.

12. The wireless receiver of claim 11, wherein said processing subsystem further computes an estimated distance in conformity with said computed variance, and determines whether or not said estimated distance is within said proximity range.

13. The wireless receiver of claim 12, wherein said processing subsystem further determines whether or not said variance falls within one or more predetermined ranges, whereby a proximity level of said distance is determined.

14. The wireless receiver of claim 13, wherein said processing subsystem denies access of said first wireless device to said second wireless device, in response to determining that said variance is greater than an upper bound of a given one of said predetermined ranges.

15. The wireless receiver of claim 14, wherein said processing subsystem denies access to a subset of services available at said second wireless device, in response to determining that said variance is greater than an upper bound of a given one of said predetermined ranges.

16. The wireless receiver of claim 15, wherein said processing subsystem is coupled to an electromechanical lock and said subset of services includes opening said electromechanical lock.

17. The wireless receiver of claim 11, further comprising a display coupled to said processing subsystem for providing an indication to a user of a result of said determining, whereby said user can take further action.

18. A wireless communication system, comprising:
a first transceiver, including a first amplitude detector coupled to a first receiver subsystem of said first transceiver for detecting an amplitude of first signals received by said first transceiver, and a first processing subsystem coupled to said first amplitude detector for computing a first variance of said first received signals; and
a second transceiver, including a second amplitude detector coupled to a second receiver subsystem of said second transceiver for detecting an amplitude of second signals received by said second transceiver, and a second processing subsystem coupled to said second amplitude detector for computing a second variance of said second received signals, and wherein said second transceiver transmits a second variance indication in conformity with said second variance to said first transceiver.

19. The wireless communication system of claim 18, wherein said first transceiver receives said second variance indication and determines whether or not said first transceiver is within a proximity range of said second transceiver in conformity with said computed first variance and said received second variance indication.

20. The wireless communication system of claim 18, wherein said second transceiver further determines whether or not said first transceiver is within a proximity range of said second transceiver in conformity with said computed second variance and transmits a result of said determining as said second variance indication, whereby said first transceiver may determine whether said first transceiver and said second transceiver are in proximity in conformity with said computed first variance and said received second variance indication.
